(19) United States
(12) Patent Application Publication
(10) Pub. No.: US 2006/0289762 A1
(43) Pub. Date: Dec. 28, 2006

(54) Thermal direction unit

(76) Inventors: Ronald F. Hackney, Safety Harbor, FL (US); Douglas W. Hackney, Philadelphia, PA (US)

Correspondence Address: Christopher Kay;Law Office of Christopher Kay, Suite 100, 3111 W. Dr. M. L. King Jr. Blvd., Tampa, FL, 33607, US

(21) Appl. No.: 11/498,918

(22) Filed: Aug. 2, 2006

Related U.S. Application Data
(63) Continuation-in-part of application No. PCT/US05/11980, filed on Apr. 7, 2005.
(60) Provisional application No. 60/560,467, filed on Apr. 7, 2004.

(51) Int. Cl. G01J 5/00

(52) U.S. Cl. 250/338.1

(57) ABSTRACT

A device, and method for its use, which may be worn by a firefighter for detecting the source of a fire in a smoke-filled or noisy environment, the device having directional infrared sensors for detecting the direction of maximum or minimum intensity of infrared radiation in two or more directions relative to the wearer and reporting at least the direction of maximum or minimum intensity to the wearer by a tactile indicator contacting the skin of the wearer.

### CROSS-REFERENCE

This application is a continuation-in-part of co-pending International Application No. PCT/US2005/011980, filed Apr. 7, 2005, the benefit of priority of which is claimed, and which in turn claims the benefit of priority of U.S. Provisional Application Ser. No. 60/560,467, filed on Apr. 7, 2004, the benefit of priority of which is also claimed, the contents of both applications being incorporated herein in their respective entireties by reference, and which are not admitted to be prior art with respect to the present invention by their mention in the background.

### FIELD OF THE INVENTION

The present invention relates to a device for detecting the direction of a heat source. More particularly, the invention relates to a device that may be worn and used for detecting and indicating, preferably by a tactile indication to the wearer, the direction of maximum or minimum infrared radiation relative to the wearer. The present invention also relates to methods for using said device, for example for locating a fire in a smoke-filled room or locating a direction away from a fire.

### DESCRIPTION OF RELATED ART

A firefighter entering a burning building may be faced with a variety of impediments hindering the firefighter's ability to locate and fight the fire. Smoke usually obstructs the firefighter's vision, making identification of the source of the smoke difficult. Ambient noise from the site of the fire, or “fireground,” wind, and heavy protective firefighting equipment, such as breathing equipment, also may impede the firefighter's hearing, so that audible clues to the location of the fire are masked. Unseen obstacles (furniture, doorways, debris, and the like) may impede the firefighter's progress and cause the firefighter to lose his sense of direction, which further hampers the search for the source of the fire. To avoid smoke and heat, firefighters must often crawl upon the floor, making identification of the source of the fire yet even more problematic.

In addition to identifying the source of a fire, a firefighter must also be alert to the dangers of imminent flashover and related rapid fire progress phenomena. For example, flashover may occur in a compartment fire when total thermal radiation is sufficiently high that flammable products of pyrolysis are generated from all exposed combustible surfaces within the compartment. Given a source of ignition, this results in the sudden (frequently explosive) and sustained transition of a growing fire to a fully developed fire. Flashover is often fatal to a person remaining in the room or compartment. A related phenomenon is smoke explosion in which the temperature reaches a level sufficient to ignite smoke particles forming an explosive and usually fatal fireball. It is therefore important for a firefighter to know when temperatures are approaching those required to trigger rapid fire progress phenomena (approximately 600° F.) so that he may take appropriate action, including moving away from the fire to a safer location.

Heat sources such as fire emit infrared radiation invisible to the human eye that can propagate through fog, rain, smoke, and mist. By detecting infrared radiation, the source of a fire may be located as may a direction leading away from the fire. In addition, hot spots prone to flare-up may also be located.

U.S. Pat. No. 6,674,080 to Trampala et al. discloses a handheld infrared sensing device capable of detecting heat sources and hot spots and which produces a sound that indicates radiation intensity. From the perspective of a firefighter, this device suffers from the drawback that the device is handheld whereas the firefighter's hands are usually engaged in other tasks. Thus, operating this device takes precious extra time. Also, the audible signal may be masked by the loud ambient noise characteristic of a fireground.

U.S. Pat. No. 4,800,285 to Akiba et al. discloses an automated flame detecting apparatus that provides an indication of the direction of a fire. A predetermined area is mechanically scanned using a photodiode or phototransistor and the output is analyzed directionally and temporally to identify the location of a fire and to trigger an alarm and/or fire control equipment. While the apparatus of Akiba et al. may be suitable for automatic, slow fixed monitoring of a location, this approach is unsuited to the complex, dangerous and dynamic environment faced by a firefighter, where instantaneous, easily perceived, directional information is required that will constantly change as the firefighter moves in relation to the fire.

U.S. Pat. No. 5,433,484 to Brogi et al. discloses an improved infrared fire detector adapted for fixed deployment in the detection of heat sources in the natural environment. The device is adapted to detect infrared radiation between about 2.5 and about 5.0 microns, a wavelength range that reduces susceptibility to false alarms by discriminating against solar radiation reflections and fluctuations in ambient background temperature. While well adapted to outdoor, static applications, the device is not suitable for the dynamic environment of indoor firefighting in which solar radiation plays an insignificant part.

U.S. Pat. No. 6,518,574 to Castleman discloses a sophisticated, microprocessor controlled, multi-sensor detector for hydrocarbon fires, which uses infrared detectors of different spectral ranges coupled to digital signal processing and spectral analysis to improve discrimination between hydrocarbon fires and false alarms. The device is expensive and suitable only for use in fixed applications.

U.S. Pat. No. 5,218,345 to Muller et al. discloses a fixed, scanning device for monitoring infrared radiation over an extended area from an elevated location. False alarms are minimized by the use of paired detectors and differential circuitry, which also permits reliable detection of distant fires. The approach is not advantageous to firefighters operating at close range in confined areas such as within a smoke-filled building.

There is therefore a need in the firefighting art for a fire detection unit capable of indicating to a firefighter the location of a source of heat at a fireground in real time, or indicating a direction leading away from a source of heat, through smoke, through loud ambient noise, despite the wearing of bulky firefighting equipment, and without causing the firefighter to stop, or require that the firefighter use hands that are otherwise occupied. The above-mentioned needs are provided, and the above-mentioned deficiencies in the prior art are avoided, by the invention described herein, as will become readily apparent upon reading the following disclosure, claims, and figures.

### SUMMARY

In a first embodiment, the present invention provides a thermal direction unit (TDU) that may be worn by a subject. This embodiment comprises a plurality of directional infrared sensors for detecting the intensity of infrared radiation in a plurality of directions disposed radially about the subject. This embodiment further provides electronic means for comparing the detected infrared radiation intensities of the sensors in order to determine the direction of maximum or minimum detected infrared radiation intensity, and thereby temperature, relative to the subject. This embodiment yet further provides a means providing the subject with a tactile indication of the direction of maximum or minimum detected infrared radiation intensity relative to the subject, such as by the operation of a buzzer vibrationally coupled to the skin of the subject.

In a second embodiment, the invention provides a thermal direction unit (TDU) that may be mounted to a helmet or headgear, which is capable of providing a wearer with a tactile indication of the direction of maximum or minimum detected infrared radiation relative to the wearer. In this embodiment, the TDU has an essentially toroidal casing comprising an upper and a lower casing forming, when connected, at least one interior cavity. The cavity comprises a plurality of directional infrared sensors capable of detecting the intensity of infrared radiation from a plurality of directions. The casing further contains a means for comparing the detected infrared radiation intensities of the sensors in order to determine the direction of maximum or minimum detected infrared radiation intensity relative to the subject. Further, the cavity contains a means for providing a tactile indication of the direction of maximum or minimum detected infrared radiation intensity relative to said subject, and a power source such as one or more batteries. In this embodiment, the TDU further comprises means for mounting the casing to a helmet or the like.

In a third embodiment, the invention provides a method for locating a fire, in which a subject, wearing a TDU of the present invention adapted to detect the direction of maximum infrared radiation intensity moves, either directly or indirectly, in the direction indicated by the tactile indication produced by the TDU, and/or moves the TDU while remaining in one location, until the fire is located.

In a fourth embodiment, the invention provides a method for locating a route away from a fire, in which a subject wearing a TDU of the present invention adapted to detect the direction of minimum infrared radiation intensity moves, either directly or indirectly, in the direction indicated by the tactile indication produced by the TDU, and/or moves the TDU while remaining in one location, until a route leading away from the fire is determined.

### BRIEF DESCRIPTION OF THE DRAWINGS

FIG. 1 shows a perspective view of a preferred embodiment of the TDU of the present invention.

FIG. 2 shows an exploded view of a preferred embodiment of the TDU of the present invention.

FIG. 3 shows a perspective view of the main circuit board mounted in a lower casing of a preferred embodiment of the TDU of the present invention.

FIG. 4 shows a perspective view of an infrared detector circuit board mounted in a lower casing of a preferred embodiment of the TDU of the present invention.

FIG. 5 shows a schematic circuit diagram of an infrared detector circuit of a preferred embodiment of the TDU of the present invention.

FIG. 6 shows a schematic circuit diagram of a preferred embodiment of the TDU of the present invention.

FIG. 7 shows a schematic circuit diagram of a second preferred embodiment of the TDU of the present invention that is switchably adapted to detect the direction of maximum or minimum infrared radiation intensity.

FIG. 8 shows a schematic circuit diagram of an infrared detector circuit of a second preferred embodiment of the TDU of the present invention.

### DETAILED DESCRIPTION

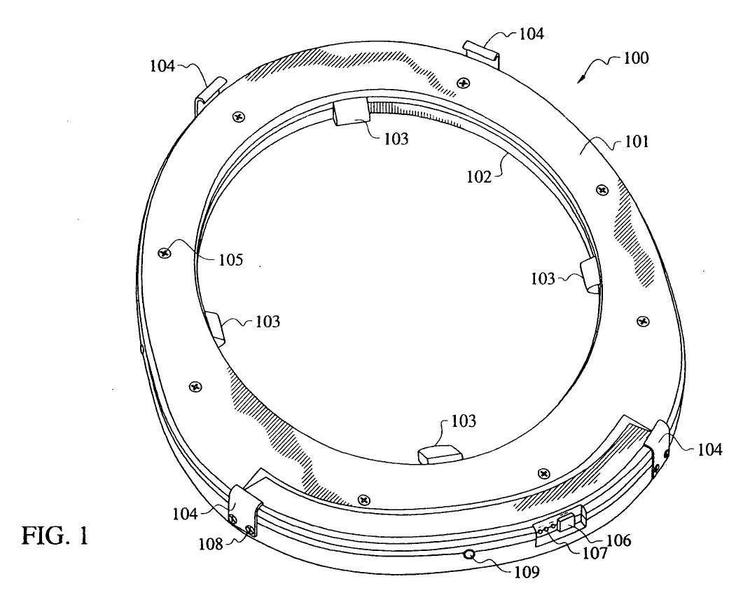

The configuration of a preferred embodiment of the thermal direction unit (TDU) of the present invention will now be described with reference to FIGS. 1-6, in which like numerals refer to like parts throughout. The following preferred TDU embodiment is described for illustrative purposes only, and is not to be construed as limiting the scope of the claims herein.

Referring now to FIG. 1, the construction of a preferred thermal direction unit 100 embodiment is illustrated, in which the TDU comprises an upper casing 101 affixed to a lower casing 102 to form an essentially toroidal structure having one or more interior cavities. The materials of the upper and lower casings may be any rigid, semi-rigid, or flexible material capable of withstanding the rigors of a firefighter's environment. A TDU within the scope of the present invention may be constructed from flexible materials and derive its rigidity in whole or in part from its attachment to a helmet. Preferably, the upper and lower casings are constructed from a rigid, injection-moldable, heat-resistant polymer, and the upper and lower casings preferably provide a watertight seal for the one or more interior cavities when the casing is in its assembled state. Optionally, a water resistant cover enclosing the TDU is provided. The upper and lower casings of the embodiment of FIG. 1 are affixed to each other by a plurality of casing connectors 105, such as screws, bolts, rivets, spot welds, or the like. The essentially toroidal structure of this embodiment is optionally adapted to be attached to a helmet by a plurality of wearer attachment means 104 affixed to the exterior of the TDU by wearer attachment means connectors 108. Preferably, the TDU is attached to the rim or underside of a firefighter's helmet. In the embodiment of FIG. 1, the wearer attachment means are clips adapted to engage the rim of the fireman's helmet. Other attachment means well known in the art, such as cords, hooks, springs, zippers, buttons, and the like, are also useable to secure the TDU to a helmet. Alternatively, the TDU forms an integral part of the construction of the fireman's helmet, or is adapted for wearing other than on the head, for example upon the wrist or waist of a subject.

It is not essential that the TDU of the present invention have a rigid casing. In certain embodiments, for example where mounting to helmets of different sizes or designs is desired, it is advantageous for all or parts of the TDU casing to be semi-rigid or flexible in order to facilitate mounting the TDU to the helmet. For example, in such embodiments one or more portions of the casing are capable of lengthening and shortening, and/or of changing their position in relation to one another, in order to facilitate attachment to diverse helmet designs and sizes.

The TDU of the present embodiment further comprises a plurality of infrared detectors assemblies 109 disposed to detect incident infrared radiation from a plurality of directions. The infrared detectors provide a direct measurement of incident infrared radiation intensity which, depending on the sensor used, is also a direct or indirect indication of temperature. Accordingly, the terms “detected infrared radiation intensity” and “detected temperature” and their equivalents are used interchangeably herein. Preferably, from two to twenty infrared detectors are used. Most preferably four detectors are used and are preferably directed to four mutually perpendicular directions in a plane, corresponding to the front, back, left and right sides of a wearer. However, a non-planar arrangement of infrared detectors is also within the scope of the present invention. Each detector is associated with one or more tactile contacts 103 disposed upon the TDU to permit a tactile indication to be transmitted to the wearer's skin for perception by the wearer.

The TDU preferably comprises a means for activating and deactivating the TDU such as an on/off switch 106 or a switch responsive to a magnetic field, radio signal, or the like. Most preferably, an on/off switch is provided on the external surface of the TDU. In the embodiment of FIG.1, one or more indicators 107 are provided to signal to the wearer the operational status of the TDU, for example to indicate the condition of the power source, such as a “low battery” condition or “power on” condition. Indicators include LED's , audible signal generators such as piezoelectric buzzers, and may further include an indicator capable of sending a signal such as a radio signal to a remote receiver.

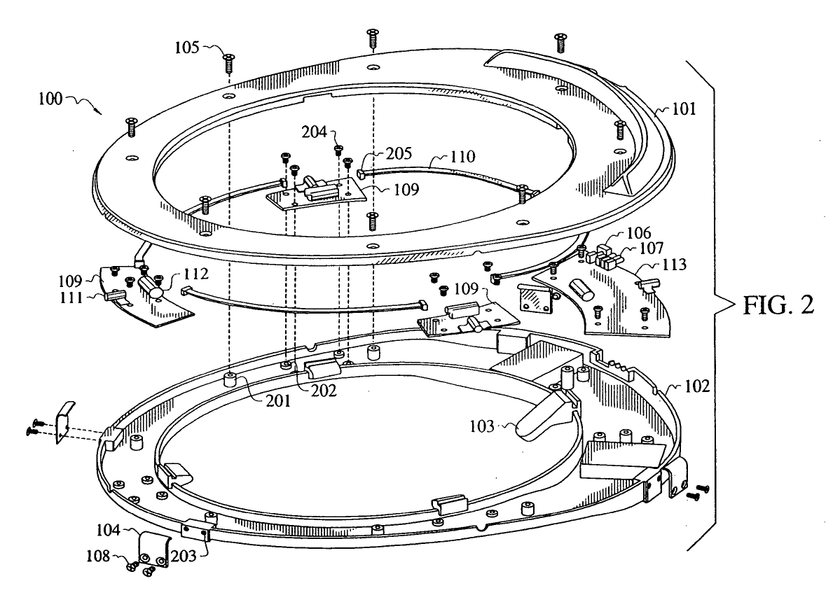

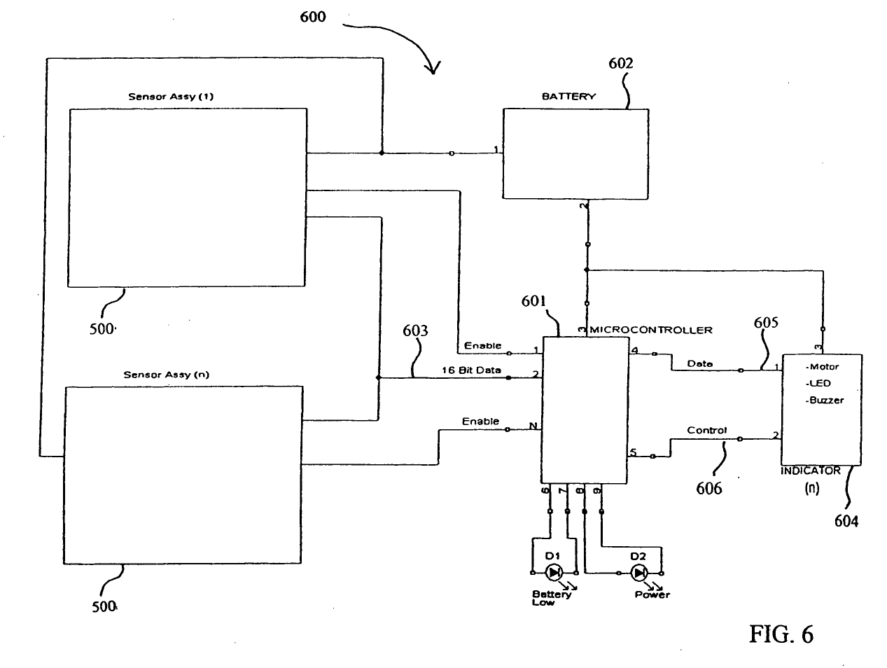

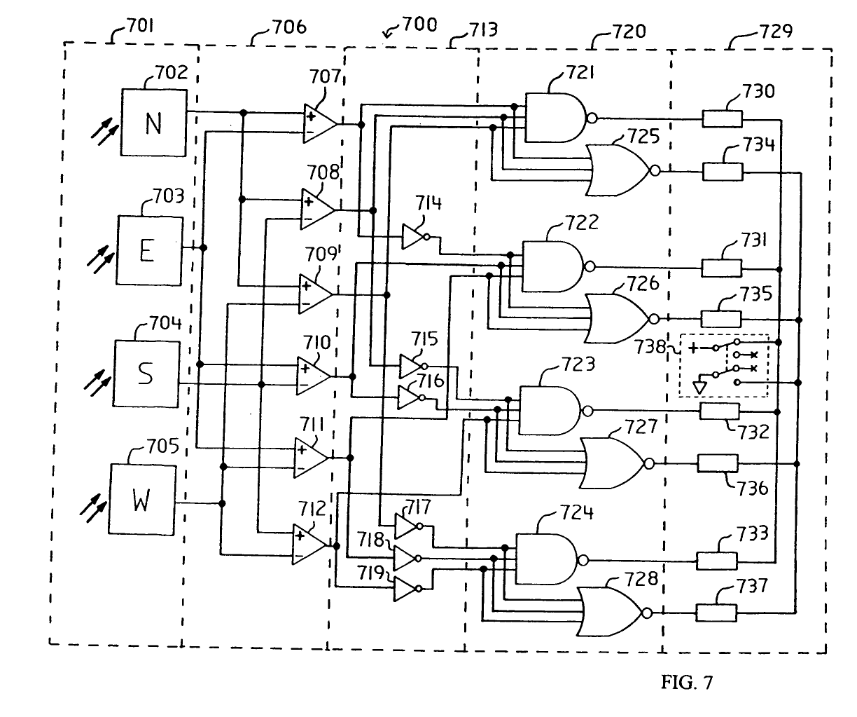

Referring now to FIG. 2, the embodiment of a TDU is shown in exploded form. Located within a cavity defined by the upper casing 101 and lower casing 102 are a plurality of circuit boards 200 comprising one or more infrared detector housings 208 containing an infrared detector 109 and further comprising a corresponding vibrating means 209, together with electronic control circuitry as depicted in FIGS. 6 and 7. The infrared detectors 109 are of any kind possessing adequate sensitivity and small size, but are preferably thermopile detectors, or photoelectric transducers such as a photodiodes or phototransistors, as are well-known in the art, and which are capable of detecting with sufficient sensitivity a suitable infrared wavelength range corresponding to the infrared emission of a burning or smoldering object. The directional detection ability is a characteristic of the detector, or the angle of detection is further reduced as needed by recessing the detector within the TDU or by a lens.

The circuit boards 200 are electrically connected to each other by a wiring harness 206 via wiring harness connectors 205. In the embodiment of FIG. 2, circuit boards are secured to lower casing 102 by circuit board connectors 204 engaging circuit board connector attachments 202.

In this embodiment, wearing attachment means connectors 108 engage wearing attachment means attachments 203, and casing connectors 105 engage casing connector attachments 201.

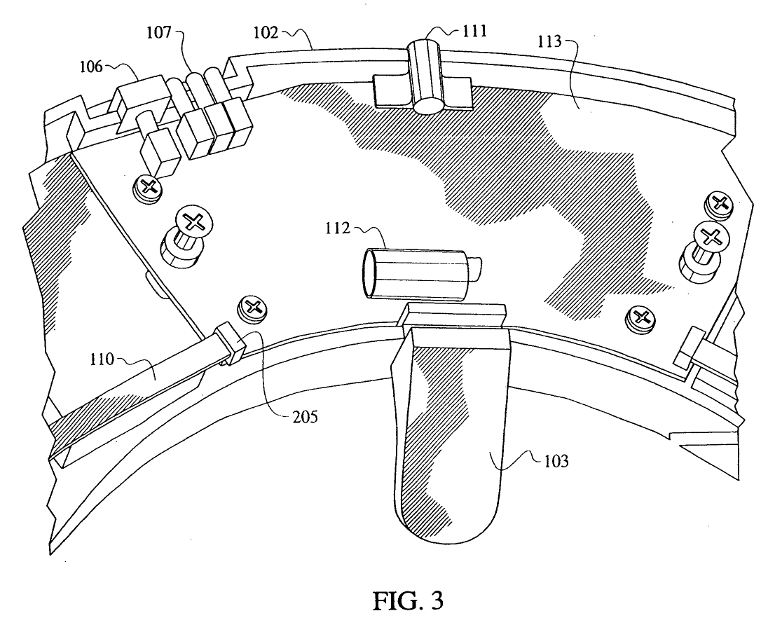

Referring now to FIG. 3, main circuit board 113 is shown secured to lower casing 102 and connected to wiring harness 206 via wiring harness connectors 205. The means by which electrical connections are made among the plurality of infrared detectors is not particularly limited, and may be made by any secure and robust connector known in the art. One circuit board 200 is optionally further adapted to hold an electrical power source, a switch 106, an optional indicators 107 such as a battery level indicator, and/or optional power indicator, and/or circuitry such as a microprocessor or analog or digital signal processor for determining the direction of maximum infrared radiation intensity.

FIG. 3 also illustrates a vibrating means 209 which is used to produce a tactile indication in the wearer. The term “tactile indication” as used herein includes any stimulus that can be perceived by the skin of the wearer, which may include for example a vibrational stimulus or an electrical stimulus applied to the wearer's skin. The preferred tactile indication is a vibration, which may be provided by any electromechanical or piezo device capable of providing vibration of a frequency and amplitude capable of perception by the wearer. Preferably, an electromechanical device is used that comprises a small electric motor connected to an eccentric load whereby a vibration is produced, such devices being well known in the cell-phone art. An electromechanical vibrator is shown as the vibrating means 209 in the embodiment of FIG. 3, in which the vibration is transmitted to the skin of a wearer by tactile contact 103 located in vibrational proximity to vibrating means 209, and constructed of a material capable of transmitting the vibration and of contacting the wearer's skin without abrasion. Rubber or a synthetic equivalent is preferred.

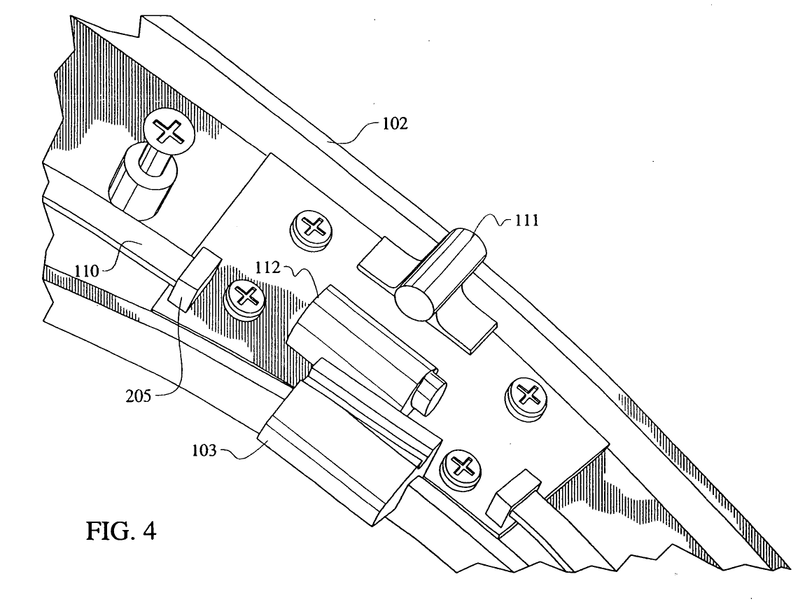

Referring now to FIG. 4, a circuit board 200 comprising infrared detector housing 208, and vibrating means 209, is secured to lower casing 102, and is connected to wiring harness 206 via wiring harness connector 205.

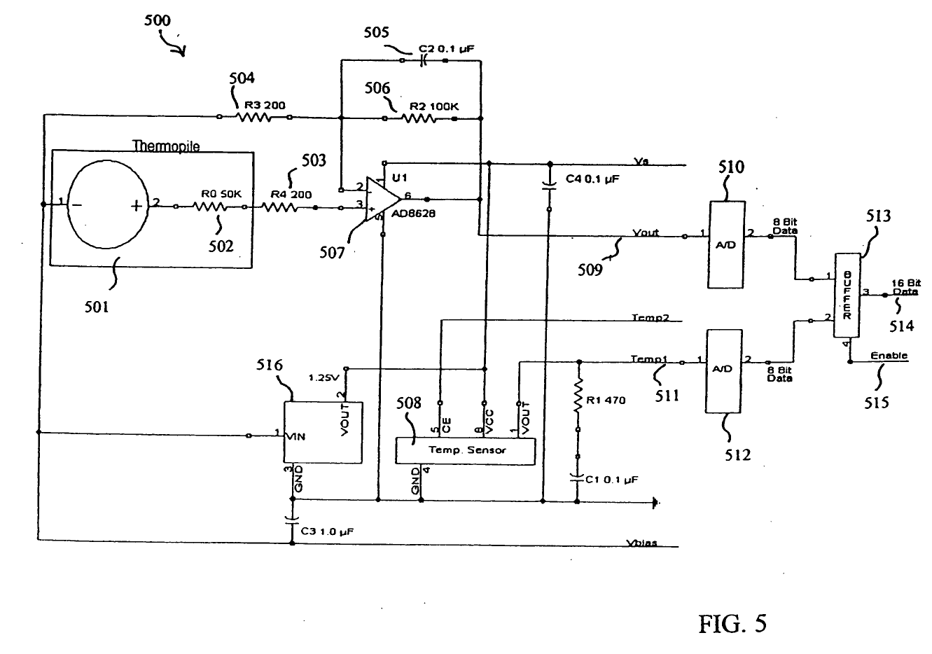

The electrical operation of an embodiment of the TDU is now explained in general terms, and then circuit diagrams of a preferred embodiment are described as shown in FIGS. 5 and 6. In operation, each of the plurality of infrared detectors 109 provides an output corresponding to the intensity of infrared radiation of the appropriate infrared wavelength range that is incident upon the detector. Each output is amplified by an amplifier of appropriate gain and frequency response, and the amplified outputs are electronically compared to identify the sensor having the greatest incident infrared intensity. Optionally, means are provided to compensate for variations in infrared detector sensitivity due to, for example, variation in the temperature of the detector itself. Once the detector having the greatest incident infrared intensity is identified, the device adjacent to that sensor for providing a tactile indication to the wearer is activated.

Preferably, a microcontroller or comparator is used: (i) to compare detector outputs according to a predetermined program, (ii) to compensate for the temperature of the detectors themselves, and/or (iii) to correct for non-linearity in the response of the detectors according to pre-determined and stored detector response data. A predetermined program for comparing detector outputs includes programs that determine the single detector having the maximum output, but the term also encompasses a program that causes the identification of more than one detector if the outputs of the detectors are similar according to predetermined criteria.

In basic operation, the TDU is optionally mounted to a firefighter's helmet, switched on, and worn by a subject. Preferably, four means of providing a tactile indication contact the wearer's skin at four points about the circumference of the head. Based upon the determination of the direction of maximum detected infrared intensity, one or more indicators are energized and perceived by the wearer. As the wearer scans his thermal environment by moving his head, different vibrators will become energized depending upon which detector or detectors is directed towards the heat source. By this means, the wearer is able to perceive the direction of a detected heat source without the necessity of being able to see, hear, use his hands, or stop moving. The wearer may then approach the source of the infrared radiation by moving in the direction indicated by the tactile indication. If a direct path is blocked, a wearer moves around the blockage and then continues to approach the source of the heat as before. By this method, heat sources may be located and approached even in a smoke-filled, noisy environment. Obviously, a reverse process may be used to search for a path away from a heat source.

FIGS. 5 and 6 show exemplary embodiments for illustrative purposes.

Referring now to FIG. 5, a sensor assembly circuit 500 is shown according to a preferred embodiment. The infrared detector of this embodiment is thermopile 501 (e.g. ST60, Dexter Research, Inc.), which has internal resistance 502 (required for gain calculation) and provides an output voltage that is proportional to the temperature sensed. The output voltage is amplified by an amplification circuit comprising amplifier 507 and feedback an frequency control elements 503-506, which provide a gain of about 500 for the values shown in FIG. 5. A temperature compensation circuit is provided, in which a sensor 508 (e.g. LM20) is positioned to sense the temperature of the thermopile 501 body. The amplified thermopile output 509 is provided to a first 8-bit analog-digital converter 510 (e.g. AD 7468), and the analog signal corresponding to the thermopile body temperature 511 is provided to a second 8-bit analog-digital converter 512 (e.g. AD 7468). Buffer 513 (e.g. 74ACT244) combines the two 8-bit signals into a 16-bit word 514 that is polled by the microprocessor of FIG. 6 according to the signal applied to its enable line 515. Voltage is regulated by regulator 516 (e.g. LT1790AIS6-1.25).

Referring now to FIG. 6, there is shown a schematic TDU circuit diagram 600 of a preferred embodiment of the TDU of the present invention. Microcontroller 601 (e.g. ATTINY11, ATTINY12, ATTINY15, AT1200, AT2323, or AT2343 from ATMEL; PIC12C508, PIC509, PIC519, PIC12C671, or PIC12C672 from MICROCHIP) is powered by non-explosive battery 602 (e.g. 3.6V NiCad pack consisting of 3 AAA batteries). A plurality (n) of sensor assembly circuits 500 are polled by microcontroller 601 according to a predetermined program via a 16-bit data bus 603 and n enable lines 515. Each buffer 513 is selected by its enable line 515, which allows the data to be read by the microcontroller. The microcontroller adjusts the thermopile digital value according to the digital sensor body temperature according to a predetermined program. The sensor assembly sensing the highest incident infrared radiation is then determined by the microcontroller according to a predetermined program. The microcontroller is connected to n indicators 604, corresponding to the n sensor assemblies, by sensor data bus 605 and sensor control bus 606, whereby the indicator or indicators corresponding to the sensor assembly sensing the highest incident infrared radiation is activated.

Referring now to FIG. 7, there is shown a schematic circuit diagram 700 of a second embodiment of the TDU of the present invention that is switchably adapted to detect the direction of maximum or minimum infrared radiation intensity. For illustrative purposes only, the circuit is divided into five stages: a detector stage 701, a comparator stage 706, a signal conditioning stage 713, a signal analysis stage 720, and an output stage 729. Circuit diagram 700 illustrates one means for comparing the detected infrared radiation intensities of said sensors to determine the direction of maximum or minimum infrared radiation intensity relative to said subject.

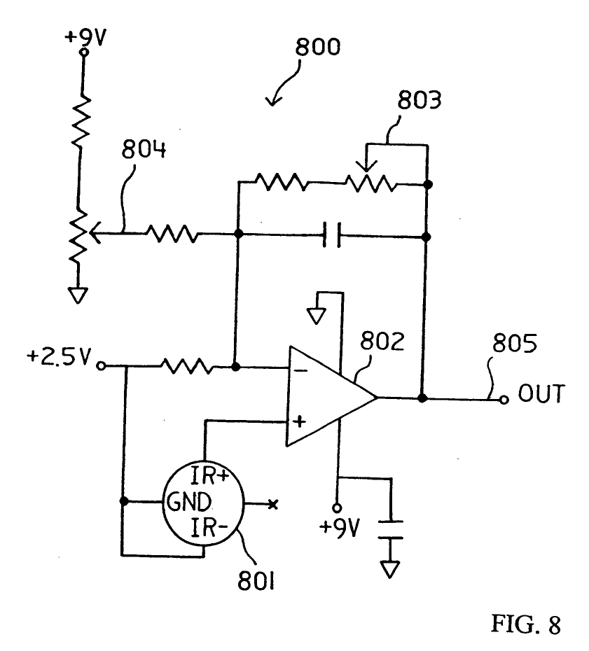

The detector stage 701 comprises a plurality of directional infrared sensor circuits (702-705, and FIG. 8) each of which provides an output voltage indicating the intensity of detected infrared radiation in a particular direction.

Pairwise comparisons of the output voltages of the sensor circuits (702-705) are performed in a comparator stage (706). The comparators can be constructed in many different ways as is well-known in the art. For example, dedicated comparator integrated circuits such as LM306, LM311, LM393, LM339, or NE529 are suitable, as are comparators constructed from discrete transistors such as a Schmitt trigger, or operational amplifiers can be used either with feedback, or without feedback and operating at saturation. The output of comparator 707 is high if the intensity of infrared radiation detected by directional infrared sensor circuit 702 is greater than that of sensor circuit 703 (N>E). Comparators 708 (N>S), 709 (N>W), 710 (E>W), 711 (E>W), and 712 (S>W) collectively provide all pair wise comparisons of the sensor circuit outputs and the circuit 700 can be readily adapted to a different number of sensor circuits.

In a signal conditioning stage 713, inverters 714-719 condition the comparator signals for signal analysis stage 720. Inverters of the 04 or C04 TTL or CMOS type are suitable, as are specific inverter families such as CD4069, MM74C901, MM74C907, CD4049A, MM74C14 or MM74C914. Inverters comprising discrete transistors are also known. Certain of the pair wise comparison signals are inverted to facilitate determination of the sensor circuit 702-705 having the highest or lowest output voltages using simple NAND and NOR gates in signal analysis stage 720.

In a signal analysis stage 720, multiple input NAND and NOR logic gates are used to generate signals to identify the sensor circuits 702-705 having the highest and lowest output voltages. NAND gate 721 produces a low output if sensor circuit 702 has the highest output voltage, and NOR gate 725 produces a high output if sensor circuit 702 has the lowest output voltage. Similarly, gates 722 and 726, 723 and 727, and 724 and 728, analyze the output voltages of sensor circuits 703, 704, and 705, respectively. NAND gates such as the well known 10 series TTL and CMOS families are suitable, as are specific examples such as SN74LS10 and CD4023 (Texas Instruments). NOR gates such as CD4025B, CD54HC27, CD74HC27 (Texas Instruments) and equivalent multi-input CMOS or TTL NOR gates from other manufacturers are suitable. It will be appreciated by those of ordinary skill that signal analysis stage 720 can be readily adapted for more or fewer sensors, and can be implemented in diverse ways.

Output stage 729 illustrates one embodiment of a means for providing a tactile indication of the direction of maximum or minimum detected infrared radiation intensity to a subject. If switch means 738 is in a first position as shown, means 730-733 for providing a tactile indication, such as a vibrating means, are connected to a positive supply voltage whereby the means for providing a tactile indication that corresponds to the sensor circuit having the highest output voltage is activated. If switch means 738 is in a second position, means 734-737 for providing a tactile indication are connected to ground whereby the means for providing a tactile indication that corresponds to the sensor circuit having the lowest output voltage is activated. In the schematic circuit of FIG. 7, pull-up resistors, power connections and the like are omitted for clarity, as will be readily apparent to one of ordinary skill.

Referring now to FIG. 8, there is shown a schematic circuit diagram of an infrared detector circuit 800 according to the second embodiment of the TDU of the present invention. Thermopile 801 is biased through its ground and IR− connections to an intermediate voltage and the output (IR+) is connected to operational amplifier 802, which is provided with a conventional feedback loop to amplify the thermopile output voltage. Variable resistors 803 and 804 provide gain and offset adjustment, respectively, whereby the output voltages of the plurality of sensor circuits can be calibrated to each other.

Further embodiments with additional featured will be readily apparent to one of ordinary skill and are also envisaged as being within the scope and spirit of the present invention.

In a first example, in addition to providing a tactile indication of the direction of maximum infrared intensity, the vibrating means are operated according to a predetermined algorithm that provides more detailed information of the detected thermal environment. In one embodiment, the vibrating means are pulse-modulated, for example by varying the pulse frequency or intensity of the vibrating means in order to convey to the wearer an indication of the intensity of the detected infrared radiation and thereby the temperature. Sensor data bus 605 and sensor control bus 606 are capable of providing, with minor adaptation, sophisticated control because more data and control lines are provided than are required for simple on/off operation. Further, in another embodiment specific predetermined pulse sequences are used as warnings to indicate that predetermined threshold temperatures of particular significance have been exceeded, for example a predetermined pulse sequence that signals the danger of imminent flashover or related rapid fire progress phenomena is provided.

In a second example, the vibrating means are supplemented with one or more additional sensory output devices to convey to the wearer more complete data relating to his thermal environment. Visual devices, such as light emitting diodes (LEDs), illuminated bar displays, or illuminated displays capable of displaying text such as specific warnings, or numbers such as detected temperature, or symbols such as symbols depicting suggested actions or imminent dangers, are positioned within the wearer's field of view, preferably within his peripheral field of view. Such positioning includes positioning the sensory output devices to induce a reflection that can be perceived by the wearer indirectly. For example, a visual device is positioned to be reflected upon the interior surface of a transparent visor of a firefighter's helmet, whereby the wearer is able to perceive the status of the visual device in a “heads up” display without having to move his head or look away from his task.

In a third example, one or more user preferences are pre-programmed into the TDU and are user-selectable. Such preferences include, for example, threshold detection limits whereby the tactile indication and/or other sensory output devices are suppressed unless the detected temperature exceeds a pre-selected threshold, such as for example 300° F., or unless a threshold difference between the detected infrared radiation intensity of different detectors is exceeded.

The foregoing is considered as illustrative only of the principles of the invention. Further, since numerous modifications and changes will readily occur to those skilled in the art, it is not intended to limit the invention to the exact construction and operation shown and described, and accordingly, all suitable modifications and equivalents may be resorted to, falling within the scope of the invention.

Now that the invention has been described,

What is claimed is:

1. A thermal direction unit (TDU) for providing a subject wearing said TDU a tactile indication of the direction of maximum or minimum detected infrared radiation relative to said subject, said TDU comprising:
(a) a plurality of directional infrared sensors mounted to said TDU, wherein said sensors are arranged to detect the intensity of infrared radiation in a plurality of directions about said subject,
(b) means for comparing the detected infrared radiation intensities of said sensors to determine the direction of maximum or minimum infrared radiation intensity relative to said subject; and
(c) means for providing to said subject a tactile indication of the direction of maximum or minimum detected infrared radiation intensity relative to said subject.

2. The TDU of claim 1, further comprising a switching means comprising a first and a second switching position, whereby selecting said first switching position provides a subject wearing said TDU a tactile indication of the direction of maximum detected infrared radiation intensity relative to said subject, and selecting said second switching position provides a subject wearing said TDU a tactile indication of the direction of minimum detected infrared radiation intensity relative to said subject.

3. The TDU of claim 1, wherein said means of part (b) is a means for comparing the detected infrared radiation intensities of said sensors to determine the direction of maximum infrared radiation intensity relative to said subject, and said means of part (c) is means for providing to said subject a tactile indication of the direction of maximum detected infrared radiation intensity relative to said subject.

4. The TDU of claim 1, comprising from 2 to about 20 said sensors.

5. The TDU of claim 4, comprising four said sensors.

6. The TDU of claim 5, wherein said sensors are arranged to detect the intensity of infrared radiation in directions corresponding to the front, rear, left, and right of said subject.

7. The TDU of claim 6, wherein the direction of maximum detected infrared radiation intensity relative to said subject is approximated as the direction of the sensor detecting the highest infrared radiation intensity.

8. The TDU of claim 6, wherein the direction of minimum detected infrared radiation intensity relative to said subject is approximated as the direction of the sensor detecting the lowest infrared radiation intensity.

9. The TDU of claim 1, wherein said TDU is mounted to a helmet.

10. The TDU of claim 9, wherein said TDU is attached to the rim of said helmet.

11. The TDU of claim 1, further comprising a water-resistant cover.

12. The TDU of claim 1, further comprising an amplifier disposed between each said sensor and said means for comparing the detected infrared radiation intensities.

13. The TDU of claim 1, wherein said means for comparing the detected infrared radiation intensities is a microprocessor or comparator.

14. The TDU of claim 13, wherein said means for comparing the detected infrared radiation intensities is a microprocessor.

15. The TDU of claim 1, wherein said means for providing a tactile indication comprises an electromechanical vibrator.

16. The TDU of claim 15, wherein said electromechanical vibrator comprises an unbalanced electric motor.

17. The TDU of claim 1, wherein said tactile indication is applied to the head of said subject by a tactile contact.

18. The TDU of claim 1, further comprising an indicator of the operational status of said TDU.

19. A thermal direction unit (TDU) for mounting to a helmet and providing a subject wearing said TDU with a tactile indication of the direction of maximum or minimum detected infrared radiation relative to said subject, said TDU comprising:
(a) an essentially toroidal casing comprising an upper and a lower casing and defining a cavity, said cavity comprising:
a plurality of directional infrared sensors, wherein said sensors are capable of detecting the intensity of infrared radiation from a plurality of directions about said casing; means for comparing the detected infrared radiation intensities of said sensors to determine the direction of maximum or minimum detected infrared radiation intensity relative to said subject;
means for providing a tactile indication of the direction of maximum or minimum detected infrared radiation intensity relative to said subject; and a power source; and
(b) means for mounting said helmet to said toroidal casing.

20. The TDU of claim 19, comprising four said sensors arranged to detect the intensity of infrared radiation in directions corresponding to the front, rear, left, and right of said subject.

21. The TDU of claim 19, wherein the direction of maximum detected infrared radiation intensity relative to said subject is approximated as the direction of the sensor detecting the highest infrared radiation intensity.

22. The TDU of claim 19, wherein the direction of minimum detected infrared radiation intensity relative to said subject is approximated as the direction of the sensor detecting the lowest infrared radiation intensity.

23. The TDU of claim 1, wherein said tactile means further provides an indication of the intensity of said detected infrared radiation.

24. The TDU of claim 1, further comprising one or more sensory output devices capable of providing additional information to the subject.

25. The TDU of claim 24, wherein said one or more sensory output device is selected front the group consisting of a light emitting diodes, an illuminated bar display, and an illuminated display.

26. The TDU of claim 24, wherein said additional information is provided to said subject as a reflected image.

27. A method for identifying a direction towards or away from a fire, said method comprising:
(a) wearing a TDU according to claim 1; and
(b) moving in the direction indicated by the tactile indication produced by said TDU until a direction towards or away from a fire is identified.

28. The method of claim 23, further comprising, after step (a), the step of moving said TDU while remaining at a single location.
